(19) United States
(12) Patent Application Publication
(10) Pub. No.: US 2010/0126607 A9
(43) Pub. Date: May 27, 2010

(54) Branching Device for a Pulsation Attenuation Network

(76) Inventor: W. Norm Shade, Cambridge, OH (US)

Correspondence Address: Hasse & Nesbitt LLC, 8837 Chapel Square Drive, Suite C, CINCINNATI, OH, 45249, US

(21) Appl. No.: 12/239,379

(22) Filed: Sep. 26, 2008

Related U.S. Application Data
(60) Provisional application No. 60/976,075, filed on Sep. 28, 2007.

(51) Int. Cl. F17D 1/20; F16L 55/04

(52) U.S. Cl. 137/599.01

(57) ABSTRACT

A branching device or transition apparatus for controlling pulsation of a fluid in a piping system includes at least one large flow channel, at least two small flow channels, and at least one divider that transitions the single large flow channel into the two small flow channels internally, wherein the wall surfaces of the internal ports are generally smooth and continuous, and wherein the divider is adapted to prevent the creation of significant disturbances in fluid flow patterns through the device Typically the area of each of the small flow channels can be between about 25% to about 75% of the large flow channels, and the branching device can safely withstand pressures of between about 125 psig to about 2500 psig.

### CROSS REFERENCE TO RELATED APPLICATION

This application claims the benefit of U.S. Provisional Application No. 60/976,075, filed Sep. 28, 2007.

### FIELD OF THE INVENTION

The present invention relates in general to the control of the flow of pressurized fluids through industrial and commercial piping systems that include one or more reciprocating (piston-type) compressor cylinders, and in particular to a branching device for aiding in controlling pressure and flow pulsations of complex pressure waves passing through these systems without causing significant system pressure losses.

### BACKGROUND OF THE INVENTION

Reciprocating compressors typically include one or more pistons that “reciprocate” within a closed cylinder. They are commonly used for a wide range of applications that include, but are not limited to, the pressurization and transport of air and/or natural gas mixtures through systems that are used for gas transmission, distribution, injection, storage, processing, refining, oil production, refrigeration, air separation, utility, and other industrial and commercial processes. Reciprocating compressors typically draw a fixed mass of gaseous fluid from a suction pipe and, a fraction of a second later, compress or blow the intake fluid into a discharge pipe.

Reciprocating compressors can produce complex cyclic pressure waves, commonly referred to as pulsation frequencies, which depend upon the operating speed and the design of the gas compression system. For example, reciprocating compressors will typically produce a one or two times the compressor operating speed pulsation frequency, depending upon their design as a single or a double acting compressor. In addition, the compressor cylinders and piping systems have individual acoustic resonance frequencies. These pressure waves travel through the often complex network of connected pipes, pressure vessels, separators, coolers and other system elements. They can travel for many miles until they are attenuated or damped by friction or other means that reduce the dynamic variation of the pressure.

Over time, the magnitude of the pulsations may excite system mechanical natural frequencies, overstress system elements and piping, interfere with meter measurements, adversely affect cylinder performance, and affect the thermodynamic performance as well as the reliability and structural integrity of the reciprocating compressor and its piping system. Therefore, effective reduction and control of the pressure and flow pulsations generated by reciprocating compressors is necessary to prevent damaging shaking forces and stresses in system piping and pressure vessels, as well as to prevent detrimental time-variant suction and discharge pressures at the compressor cylinder flanges.

In order to reduce, attenuate and/or control the amplitude of system-damaging pressure pulsations upstream and downstream of a reciprocating compressor, it has been customary to use a system of expansion volume bottles, choke tubes, orifices, baffles, chambers, etc. that are installed at specific locations in the system piping. These prior art pulsation attenuation devices can be used singly or in combination to dampen the pressure waves and reduce the resulting forces to acceptable levels. However, these devices typically accomplish pulsation attenuation by adding resistance to the system. This added resistance causes system pressure losses both upstream and downstream of the compressor cylinders. When using prior art pulsation attenuation devices, the resulting pressure drop typically increases as the frequency of the pulsation increases. These pressure losses add to the work that must be done by the compressor to move fluid from the suction pipe to the discharge pipe. Although these pressure losses reduce the overall system efficiency, this has been the accepted state-of-the-art technology for reciprocating compressor systems for more than half a century, and the efficiency penalty has been tolerated in order to improve the mechanical reliability and integrity of the system.

Although improvements in system modeling have sometimes showed improved results using traditional pulsation attenuation devices, the problem of high system pressure losses continues to be a persistent issue, especially on high flow, low ratio reciprocating compressors. The problem is more serious as energy costs and environmental regulations mandate improvements in system efficiency. For some purposes it is common to operate large reciprocal compressors at speeds ranging from 600 to 1,200 rpm, instead of the conventional low-speed (200 to 360 rpm) compressors High-flow, low ratio reciprocating compressors (generally operating at about 800 to 1,000 rpm, with pressure ratios in the range of about 1.1 to 1.8) can experience large system pressure drops with the addition of current pulsation dampeners. In some cases, system pressure drops have resulted in power losses exceeding 15 to 20%, and have been known to be as high as 30%.

As these larger high-speed reciprocating compressors have been increasingly used, pressure losses caused by the addition of traditional pulsation attenuation systems have become more problematic, due to the higher frequency pulsations that must be damped. Significant pressure losses have also been encountered on high-speed compressors in some higher ratio applications, especially when a wide range of operating conditions is required.

Therefore, the need for a new technology and method for controlling reciprocating compressor pulsations has been increasingly apparent. Such a new technology, finite amplitude wave simulation, has been successfully applied to 2-stroke and 4-stroke engines to increase specific output and reduce exhaust emissions and noise. Advanced computational technology exists for modeling and designing effective engine tuning systems for high-performance racing, recreational and industrial engine applications. However, all of the aforementioned applications of finite amplitude wave simulation technology have typically been applied (with air or low-pressure mixtures of air and fuel) at pressure levels at or near atmospheric pressure, and at no more than about 3 atmospheres of pressure.

Recently, a new technology that involves cancellation of pulsations, rather than dampening, has been used with high flow, low ratio reciprocating compressor systems. U.S. provisional patent application No. 60/954,914 to Chatfield and Crandall has been filed regarding this technology, which disclosure is incorporated herein by reference, in its entirety. This pulsation attenuation technology utilizes finite amplitude wave simulation technology or other simulation means, and includes a network of branches of pipes, called a “tuned delay loop” or “tuned loop,” located upstream and downstream of a reciprocating compressor. The tuned loops typically split the main pipe section into two parts, which are then subsequently rejoined. Typically the two wave parts travel different distances and are then recombined at a later point. The different distances will time delay or phase shift the two wave parts. This time/phase shift will cancel frequency components that are present in the repeating wave. The difference in length of the two paths can be “tuned” to the frequency of a wave to dramatically reduce the noise or pulsation in the pipe. When the difference in length is tuned to the rotating speed (rpm's) of a reciprocal compressor, the pulsations will be substantially reduced without a significant pressure loss.

In light of this new pulsation attenuation technology, a need exists for a mechanical element that enables and simplifies the fabrication and cost of the individual tuned loops. There also exists a need to provide the precise internal transition geometry, structural integrity, safety and pressure containment of any gas, including explosive, hazardous, lethal, or toxic gases, required at the divergence and convergence points of the tuned loops or branches. Therefore, a primary object of the present invention is to provide a branching device for use with pulsation attenuation technology.

### SUMMARY OF THE INVENTION

Accordingly, the present invention relates to a branching device for use with a pulsation attenuation network that significantly controls the pressure pulsation waves created by reciprocating compressor cylinders without causing significant pressure losses in the system. More specifically, the invention is a tuning section transition device intended for use with a pulsation attenuation network. The pulsation attenuation network typically includes one or more sequential stages of tuned delay loops that are split from the main pipe section and then subsequently rejoined to the main pipe section by the use of tuning section transition devices.

One aspect of the invention provides a branching device for creating a divergence point and/or a convergence point for a section of a pulsation attenuation network, the device comprising (a) a large flow channel; (b) two small flow channels; and (c) a divider that transitions the single large flow channel into the two small flow channels internally, wherein the divider is adapted to prevent the creation of significant disturbances in fluid flow patterns through the device.

Another aspect of the invention provides a branching device comprising (a) a first large flow channel; (b) a first divider adapted to transition the first large flow channel into a first small flow channel and a second small flow channel, wherein the second small flow channel is configured to diverge from the first small flow channel; (c) a third small flow channel adapted to converge with the first small flow channel into a second large flow channel; and (d) a second divider adapted to transition the first and third small flow channels into the second large flow channel, wherein the dividers are operable to prevent the creation of significant disturbances in fluid flow patterns through the device.

Another aspect of the invention provides a branching device for creating a divergence point and/or a convergence point for a section of a pulsation attenuation network, the device comprising (a) at least one large flow channel; (b) at least two small flow channels; and (c) at least one divider that transitions the large flow channel into the two small flow channels internally, wherein the divider is adapted to prevent the creation of significant disturbances in fluid flow patterns through the device, and wherein the device is adapted to accommodate flow in either direction.

The nature and advantages of the present invention will be more fully appreciated from the following drawings, detailed description and claims.

### BRIEF DESCRIPTION OF THE DRAWINGS

The accompanying drawings illustrate embodiments of the invention and, together with a general description of the invention given above, and the detailed description given below, serve to explain the principles of the invention.

FIG. 1 is a schematic view of a 1-loop pressure attenuation network (PAN) to which the present invention applies.

FIG. 2 is a schematic view of a 2-loop PAN to which the present invention applies.

FIG. 3 is a schematic view of one embodiment of a tuning section transition device of the invention as a Y-branch.

FIG. 4 is a schematic view of one embodiment of a tuning section transition (TST) as a T-branch, incorporating two branches in a single mechanical element having two legs on the same side of the element.

FIG.5 is a schematic view of embodiment of a tuning section transition (TST) as an “H-branch,” incorporating two branches in a single mechanical element having two legs on opposite sides of the element.

FIG. 6 is a summary of the cancellation frequencies of a 2-loop, 1.5 ratio PAN.

FIG. 7 illustrates the comparative effect on the suction pulsations for two parallel 9.5 in. diameter UD compressor cylinders, both operating in double-acting mode, with a current baseline pulsation bottle system and a 2-loop PAN.

FIG. 8 illustrates the comparative effect on the discharge pulsations for two parallel 9.5 in. UD diameter compressor cylinders, both operating in double-acting mode, with a current baseline pulsation bottle system and a 2-loop PAN.

FIG. 9 illustrates the comparative effect on the suction line ΔP for two parallel 9.5 in. diameter UD compressor cylinders, both operating in double-acting mode, with a current baseline pulsation bottle system and a 2-loop PAN.

FIG. 10 illustrates the comparative effect on the discharge line ΔP for two parallel 9.5 in. diameter UD compressor cylinders, both operating in double-acting mode, with a current baseline pulsation bottle system and a 2-loop PAN.

FIG. 11 illustrates the comparative effect on the specific power consumption for two parallel 9.5 in. diameter UD compressor cylinders, both operating in double-acting mode, with a current baseline pulsation bottle system and a 2-loop PAN.

FIG. 12 illustrates the comparative effect on the mass flow rate for two parallel 9.5 in. diameter UD compressor cylinders, both operating in double-acting mode, with a current baseline pulsation bottle system and a 2-loop PAN.

FIG. 13 illustrates the comparative effect on the suction pulsations for two parallel 9.5 in. diameter UD compressor cylinders, with one cylinder operating in double-acting mode and the other operating in single-acting mode, with a current baseline pulsation bottle system and a 2-loop PAN.

FIG. 14 illustrates the comparative effect on the discharge pulsations for two parallel 9.5 in. diameter UD compressor cylinders, with one cylinder operating in double-acting mode and the other operating in single-acting mode, with a current baseline pulsation bottle system and a 2-loop PAN.

FIG. 15 illustrates the comparative effect on the suction line ΔP for two parallel 9.5 in. diameter UD compressor cylinders, with one cylinder operating in double-acting mode and the other operating in single-acting mode, with a current baseline pulsation bottle system and a 2-loop PAN.

FIG. 16 illustrates the comparative effect on the discharge line ΔP for two parallel 9.5 in. diameter UD compressor cylinders, with one cylinder operating in double-acting mode and the other operating in single-acting mode, with a current baseline pulsation bottle system and a 2-loop PAN.

FIG. 17 illustrates the comparative effect on the specific power consumption for two parallel 9.5 in. diameter UD compressor cylinders, with one cylinder operating in double-acting mode and the other operating in single-acting mode, with a current baseline pulsation bottle system and a 2-loop PAN.

FIG. 18 illustrates the comparative effect on the mass flow rate for two parallel 9.5 in. diameter UD compressor cylinders, with one cylinder operating in double-acting mode and the other operating in single-acting mode, with a current baseline pulsation bottle system and a 2-loop PAN.

### DETAILED DESCRIPTION OF THE INVENTION

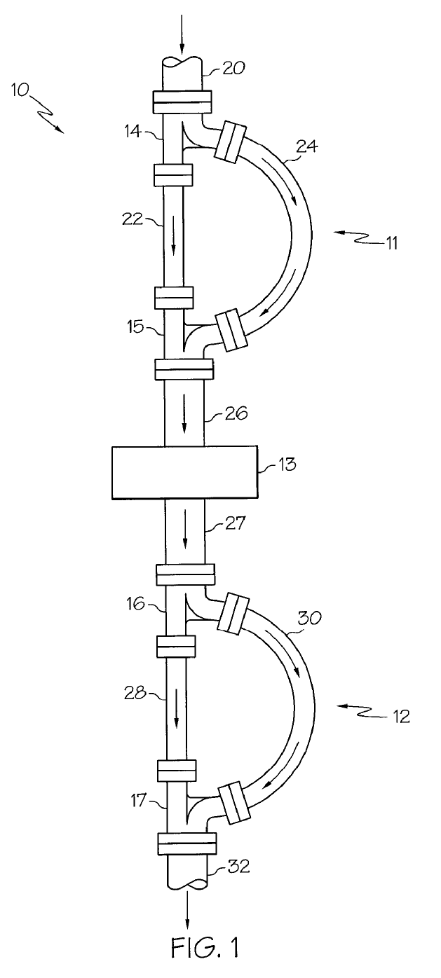

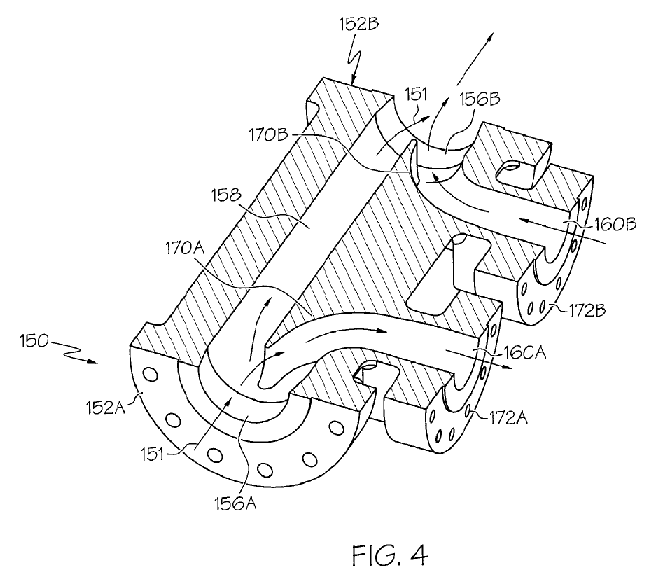

The present invention is intended for use with a Pulsation Attenuation Network (PAN), as described in U.S. Provisional Patent Application Ser. No. 60/954,914. Pulsation attenuation utilizes finite amplitude wave simulation technology or other simulation means, and includes a network of branches of pipes, called a “tuned delay loop” or “tuned loop,” located upstream and downstream of a reciprocating compressor to cancel, rather than dampen, the complex pressure waves that emanate from reciprocating compressor cylinders. The tuned loops of this pulsation attenuation system typically include two conduits such as pipes of equal area and different lengths that extend from a branching device, typically a Y-branch or a T-branch, coming off of the main pipe section. Typically, if the branch is a Y-branch (see FIGS. 1-3), then flow goes to the delay loop from a first Y-branch and then is recombined with the main pipe section via a second Y-branch. If the branch is a T-branch (see FIG. 4), then the flow goes to the delay loop at the first branching point of the device and then is recombined at the second branching point of the same device as it returns from the delay loop. The divergence and convergence points of the branches are the subject of the present invention, and the branching devices are herein termed a tuning section transition devices, or TST devices.

The TST provides hardware for adapting the theoretical simulations of PAN technology for practical application to high-pressure reciprocating compressor systems, and can control pulsations in the system without causing significant pressure losses in the system. Unlike traditional attenuation technology, this new cancellation technology has been shown on simulation to control pulsations to less than 1.0% peak-to-peak over a broad speed range, with less than 0.1% overall system pressure drop. This is a dramatic improvement over the existing traditional technology that has been applied for reciprocating compressor control, and is especially useful for large reciprocating compressors which operate at higher pressures (pressures exceeding about 3 atmospheres, generally up to about 100 atmospheres, and often up to about 300 atmospheres or higher).

FIG. 1 is a schematic illustration of a compressor cylinder 13 equipped with a simple 1-loop pulsation attenuation network (PAN) 10. Fluid flow is in the direction of the arrows. Two tuned loops or branches 11, 12 are located at both the suction inlet upstream of the compressor cylinder 13 and the discharge outlet downstream of the compressor cylinder 13. Tuning section transitions (TST) 14, 15, 16, 17 are located at the divergence and convergence points of the individual loops 11, 12. The incoming suction pipe line or main pipe 20 is split into a first leg 22 (having a length, L₁) and a second leg 24 (having a length, L₂) by the junction with the first TST 14. The length of the long second leg 24 minus the length of the shorter first leg 22 causes the time delay or phase shift. The two legs 22, 24 are merged back together at the second TST 15, the distal section of which is connected to the compressor suction nozzle pipe 26. The internal flow area of each leg 22, 24 is approximately one-half of the flow area of the incoming main pipe 20 and also approximately one-half of the flow area of the compressor suction nozzle pipe 26 at the exit of the first loop 11. For the discharge tuned loop 12, the compressor discharge nozzle pipe 27 exits the compressor cylinder 13 and is split into a third leg 28 (having a length, L₃) and a fourth leg 30 (having a length, L₄) by the junction with the third TST 16. The length of the long fourth leg 30 minus the length of the shorter third leg 28 causes the time delay or phase shift. The internal flow area of each discharge loop leg 28, 30 is approximately one-half the flow area of the compressor discharge nozzle pipe 27 at the loop entrance, and also of the discharge line 32 at its exit.

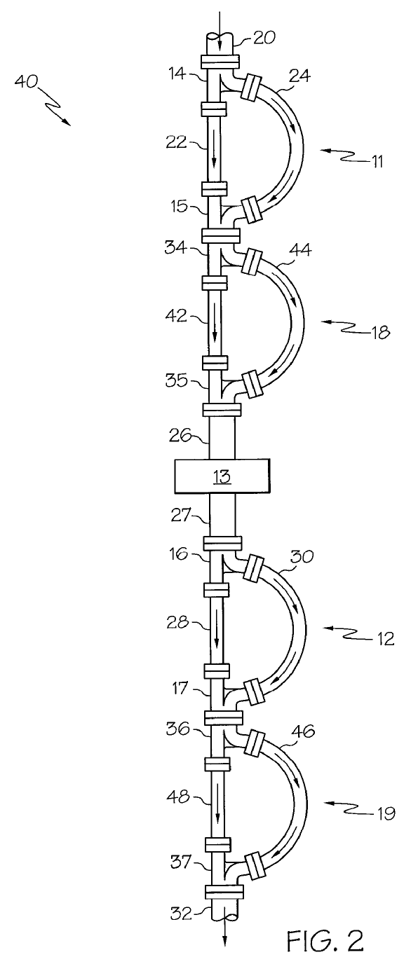

PANs may be configured as 1-loop systems (FIG. 1), or as 2-loop systems (FIG. 2) which employ two tuned loops sequentially in series. As illustrated in FIG. 2, the compressor cylinder 13 is equipped with a 2-loop PAN 40. Fluid flow is in the direction of the arrows. This embodiment includes four tuned loops 11, 12, 18 and 19, with two suction tuned loops or branches 11, 18 located upstream of the compressor cylinder 13 and two discharge tuned loops 12, 19 located downstream of the compressor cylinder 13. Upstream of the compressor TSTs 14, 15, 34 and 35 are located at the divergence and convergence points of loops 11 and 18. The incoming suction pipe line or main pipe 20 is split into a first leg 22 (having a length, L₁) and a second leg 24 (having a length, L₂) by the junction with the first TST 14. The length of the long second leg 24 minus the length of the shorter first leg 22 causes the time delay or phase shift. The two legs 22, 24 are merged back together at the second TST 15, and the third TST 34 then divides the flow of the distal section into a third leg 42 (having a length, L₃) and a fourth leg 44 (having a length, L₄). The length of the long fourth leg 44 minus the length of the shorter third leg 42 causes the time delay or phase shift. Legs 42 and 44 are merged back together at the fourth TST 35, which is connected to the compressor suction nozzle pipe 26. The internal flow area of legs 22, 24, 42 and 44 are approximately one-half of the flow area of the incoming main pipe 20 and also approximately one-half of the flow area of the compressor suction nozzle pipe 26 at the exit of the second loop 12.

Still referring to FIG. 2, the compressor discharge nozzle pipe 27 exits the compressor cylinder 13 and then passes through discharge tuned loops 12 and 19 located downstream of the compressor cylinder 13. Pipe 27 is split into a fifth leg 28 (having a length, L₅) and a sixth leg 30 (having a length, L₆) by the junction with the fifth TST 16. The length of the long sixth leg 30 minus the length of the shorter fifth leg 28 causes the time delay or phase shift. Legs 28 and 30 are merged back together at the sixth TST 17, and the seventh TST 36 then divides the flow of the distal section into a seventh leg 48 (having a length, L₇) and an eighth leg 46 (having a length, L₈). The length of the long eighth leg 46 minus the length of the shorter seventh leg 48 causes the time delay or phase shift. Legs 46 and 48 are then merged back together at the eighth TST 37, which is connected to the discharge line 32. Again, the internal flow area of legs 28, 30, 46 and 48 are approximately one-half the flow area of the compressor discharge nozzle pipe 27 at the loop entrance, and also of the discharge line 32 at its exit.

The PANs can also be configured as 3-loop systems which employ three tuned loops sequentially in series, or as systems with more than three loops sequentially in series. The tuned loop systems of FIGS. 1 and 2 work according to the theory of passive noise cancellation, which is based on the following principles:

All repeating waves of any shape with frequency “F”, period “P”, and amplitude “A” are made up of the sum of a series of sine waves with frequencies F, 2F, 3F . . . , periods of P/1, P/2, P/3 . . . , and amplitudes A1, A2, A3 . . . . These sine waves are normally referred to as the primary frequencies, F, the first harmonic frequency, 2F, second harmonic frequency, 3F, and so on. The series of sine waves is called a Fourier series. The sum of two such waves of equal amplitude but 180° out of phase is zero. I.e. the waves perfectly cancel each other [sin(X+180° )=−sin (X)].

A wave propagating down a pipe can be easily divided into two roughly equal parts with a Y-branch. If the two wave parts travel different distances and are recombined at a later point, the different distances will time delay or phase shift, the two wave parts. This time/phase shift will cancel frequency components that have periods of 2, 6, 10, and 14, etc. times the magnitude of the time delay, if they are present in the repeating wave. The difference in length of the two paths can be “tuned” to the frequency of a wave to dramatically reduce the noise or pulsation in the pipe. If the difference in length is tuned to the rotating speed (rpm's) of a reciprocal compressor, the pulsations will be substantially reduced without a significant pressure loss.

Previous applications of tuning and wave cancellation technology have been applied in air or air and fuel mixtures or post-combustion exhaust gases, principally on engine intake and exhaust systems, operating at pressures that are at atmospheric pressure or within about 3 to 4 atmospheres of pressure. As such, the systems were usually small, compact and the branches can be fabricated from thin steels or stainless steel tubing by various production means. The application of tuning and wave cancellation at elevated pressures on compressors that may have ports or flange sizes ranging from as small as about 1 inch in diameter to as large as about 24 inches or more in diameter will require that heavy tuning systems be fabricated in segments that are small enough for practical manufacture, shipment, lifting and erection. The TST of the present invention overcomes this problem by providing the most complex element of the tuned loop system, the branch, which then enables the rest of the system to be constructed of properly dimensioned and fabricated standard size industrial pipes and fittings.

Because of the elevated pressure involved in most reciprocating compressor systems, the TST branching device of the present invention is designed to safely withstand the maximum allowable working pressure of the system in which it is applied, as well as the time variant pressures in the system. These pressures are typically between about 125 psig to about 2500 psig, more typically between about 1000 psig to about 2000 psig, and even more typically between about 1200 psig to about 1500 psig. The TST can utilize standard or custom-designed flanged connections that can be secured by threaded fasteners, clamps or other means. In certain cases, the TST can be prepared with beveled ends that can be welded directly to pipes. The TST is designed to permit the use of standard, commercially available industrial pipes for the rest of the PAN system.

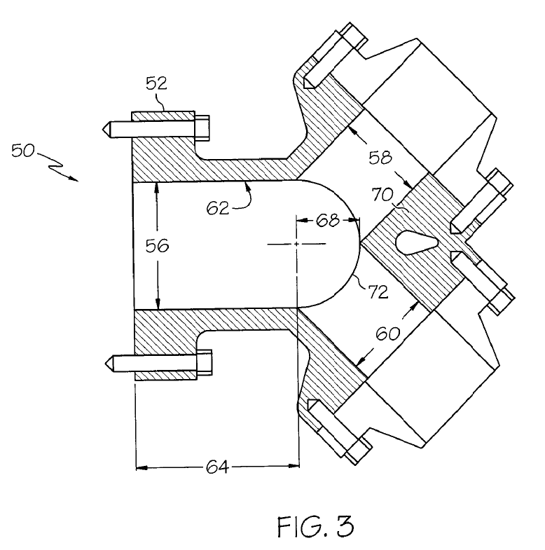

As illustrated in FIG. 3, one embodiment of the invention is a Y-shaped branching device 50, which provides the precise internal transition geometry required at the divergence and convergence points of the tuned loops or branches. The tuning section transition branching device, or TST, includes a large connection 52 with an internal port that has a large entrance or flow area 56 that will match the geometry of a duct or flange opening of a standard sized main pipe (not shown). A standard sized main pipe typically ranges from between about 4 inches to about 24 inches, so that the large connection 52 can be connected thereto. Internally, the large flow area 56 of the TST carefully and gently transitions from a single area into two smaller flow areas 58, 60, which can be, but are not limited to, between about 45% to about 55% of the large flow area 56, but may also be as little as about 25% or as large as 75% of the large flow area. Typically, however, the small flow areas 58, 60 are about 50% of the large flow area 56. Internal passage wall surfaces 62 are generally smooth and continuous, and the overall internal area of the TST 50 remains constant throughout its flow path, within a tolerance of typically, but not limited to, plus or minus 5%. At an appropriate internal distance 64, which equals a length equivalent as little as ½ diameter to as much as 3 diameters, but typically in the range of 1 diameter, along the center of the large flow area 56, a transition begins that separates the large flow area 56 into two individual smaller channel areas 58, 60. A transition zone 68 between large and small flow paths includes a divider 70, typically in the form of a tongue or splitter, which initiates the separation of the single large flow area 56 into the two small flow areas 58, 60. This internal transition between the large flow channel and the two smaller flow channels is configured with an aerodynamic profile 72. The angle that the divider 70 splits the large flow area into the smaller flow areas can be determined on a case by case basis, but typically angles of 30°, 45°, 60° and 90° are used to prevent the creation of significant disturbances in the flow patterns.

The embodiment shown in FIG. 3 illustrates a Y-branch TST that can accommodate flow in either direction, that is, either flow entering the device at the large area end and exiting through each of the smaller area ends, or flow entering at the two small area ends of the device and exiting through the single large area end. This allows the device to be applied to either the divergence point or the convergence point in the tuned loop. Accordingly, the elements 14-17 and 34-37 of FIGS. 1 and 2 are examples of the Y-branch embodiment shown in FIG. 3.

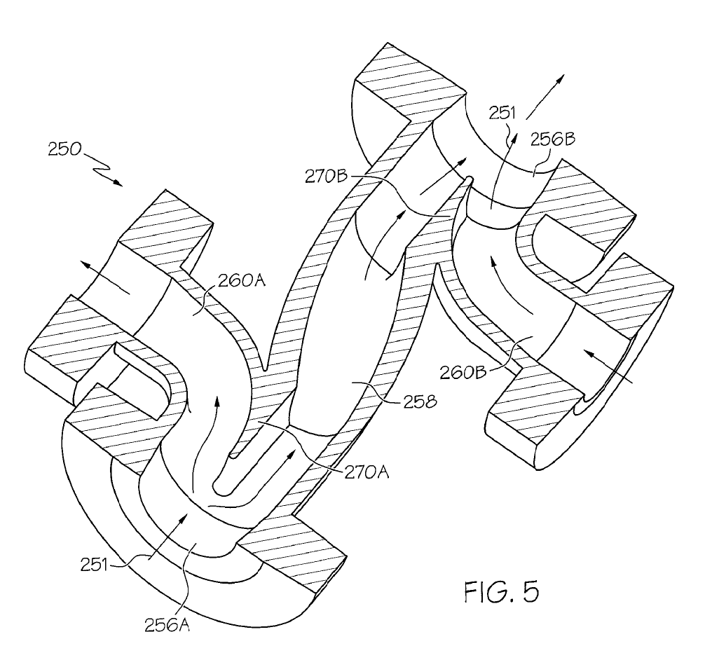

The fundamental geometry of the TST may be in the configuration of a Y-branch, as illustrated in FIG. 3, but may also be in the shape of a T-branch, or in other complex shapes (see FIG. 5, below) that facilitates the installation of a specific PAN. That is, in many cases where geometry requires, and in order to save space, cost and installation time, the short leg of the tuned loop may be included completely within the TST branching device.

As illustrated in FIGS. 4 and 5, the branching device of the invention can contain both the divergent and convergent transitions within one TST body. In FIG. 4, the T-shaped branching device 150 includes two large connections, 152A and 152B, with an internal port that has two large entrance or flow areas 156A and 156B. Direction arrows 151 indicate the direction of flow through the device. Internally, the first large flow area 156A transitions from a single area into two smaller flow areas 158 and 160A. The transition zone between large and small flow paths includes a first divider 170A, typically in the form of a tongue or splitter, which initiates the separation of the first large flow area 156A. Typically fluid exits the TST body via divergent flow area 160A, traverses a long leg port connection or loop (not shown), and then returns via convergent flow area 160B within the same branching device 150. Small convergent flow area 160B then is rejoined with small flow area 158 at the second divider 170B to form the second large flow channel 156B.

Typically the TST body of FIG. 4 has large port connections 152A and 152B for both ends of the main pipe, as well as two external port connections 172A and 172B for both ends of the tuned loop. In different embodiments of the TST, the tuned loop connections may be on the same side, such as the T-branch shown in FIG. 4, or on opposite sides, such as shown in the H-branch of FIG.5, or in other configurations that facilitate the installation of the PAN loops in areas with space constraints.

In another embodiment of the invention, illustrated in FIG. 5, the branching device 250 includes an internal port that has two large entrance or flow areas 256A and 256B. Direction arrows 251 indicate the direction of flow through the device. Internally, the first large flow channel 256A transitions from a single area into two smaller flow channels 258 and 260A. The transition zone between large and small flow paths includes a first divider 270A. Typically fluid exits the TST body via divergent flow channel 260A, traverses a long leg port connection or loop (not shown), and then returns via convergent flow channel 260B within the same branching device 250. Small convergent flow channel 260B then is rejoined with small flow channel 258 at the second divider 270B to form the second large flow channel 256B.

As noted above for FIG. 3, the smaller flow areas of FIGS. 4 and 5 can be, but are not limited to, between about 45% to about 55% of the large flow area, but may also be as little as about 25% or as large as 75% of the large flow area. Typically, however, the small flow areas are about 50% of the large flow area. The angle that the dividers split the large flow area into the smaller flow areas can be determined on a case by case basis, but typically angles of 30°, 45°, 60° and 90° are used to prevent the creation of significant disturbances in the flow patterns.

In the embodiments of the TST shown in FIGS. 1-5, the branching device typically accommodates flow in either direction, that is, flow entering the device at either end, with about half of the flow stream continuing straight through the TST and the other half of the flow stream exiting the TST through one of the side branches and after traveling through a delay loop re-entering the TST through the other side branch, and then rejoining the other half of the flow stream before exiting the TST through the other large end. Typically if the branch is a Y-branch, then flow goes to the delay loop (diverges) from a first Y-branch and then is recombined (converges) with the main pipe section via a second Y-branch (see FIGS. 1-3). However, if the branch is a T-branch or an H-branch, then the flow diverts to the delay loop at the first branching point of the device and then is recombined within the same TST body at the second branching point as it returns from the delay loop (see FIGS. 4 and 5). Direction arrows 151 and 251 in FIGS. 4 and 5, respectively, indicate one possible direction of flow through the device. However, flow can also be in the reverse direction.

Each TST is designed for a specific maximum working pressure, which is typically, but not limited to, between about 125 to about 2500 psig, more typically in between about 1000 psig to about 2000 psig, and even more typically between about 1200 psig to about 1500 psig. The TST is designed to safely contain the pressure of the working fluid within. It is typically constructed to have walls that are at least ⅜ of an inch thick, and up to as much as 2 inches or more in thickness, depending on the maximum design working pressure, in order to withstand the external forces and moments caused by the high pressures and thermal expansion acting on the piping system. The TST may be constructed from cast, forged, wrought, or welded materials, either from a single element of raw material or by the joining of two or more elements by welding or bolting, and it may be produced to near net shape via casting or welding of fabricated shapes, or machined from a solid block of material, or otherwise fabricated via other common manufacturing methods. The TST may be connected to adjacent pipes or flanges via bolted flanges, welding, compression sleeves or other means. The TST may include internal sleeves or liners for the purpose of changing the geometry, adapting the area to standard pipe sizes, providing renewable flow surfaces, or for other purposes.

In addition to customized TST designs and applications (i.e. non-standard branching configurations that are not pre-engineered and can be custom made for different angles, special pressure ratings, special mating pipe sizes, different connection means, or imbedded short pipe sections), TST configurations may include entire families of standard versions that match the required geometries, pipe flange sizes and pressure ratings prevalent in industrial reciprocating compressor applications. This will reduce the cost and increase the availability and ease of application of the new pulsation attenuation technology.

The branching devices of the present invention are typically constructed to provide structural integrity, safety and environmental leakage containment of any gas, including explosive, hazardous, lethal, or toxic gases, required at the divergence and convergence points of the tuned loops or branches used for Pulsation Attenuation Networks, and are capable of safe operation at elevated pressures.

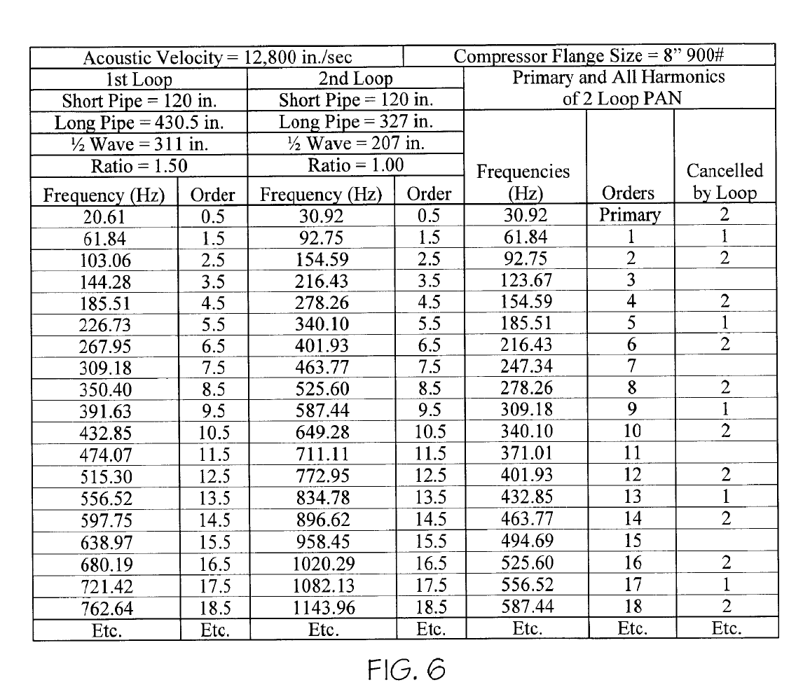

FIG. 6 is a summary of the cancellation frequencies of a 2-loop, 1.5 ratio PAN, having a schematic design similar to the 2-loop PAN system shown in FIG. 2. As illustrated, the primary and harmonic frequencies are cancelled by the 2-loop PAN on the suction side of a specific single compressor cylinder. By properly selecting the half wave frequencies, a 2-loop PAN system can effectively cancel almost all of the harmonics. For the PAN to be effective, the harmonics that are not cancelled, in this case the 3^{rd}, 7^{th}, 11^{th}, 15^{th}, 19^{th}, etc., need to be frequencies with minimal energy levels, as they are here.

Example Case: An example case of the application of this pulsation attenuation technology is discussed below. Finite amplitude wave compressor system simulation was used to model the current compressor system and also to design a tuned PAN system that effectively cancels the pressure pulsations with no significant pressure losses in the system.

The example case is a real two-cylinder field system configuration that has inlet scrubbers and primary and secondary pulsation bottles. Each side of a 6 in. stroke compressor has two 9.5 in. diameter double-acting cylinders that operate in parallel, but 180 degrees out of phase with each other. Two cylinders on each side of the compressor share common suction header bottles and common discharge header bottles. A finite amplitude wave simulation was conducted on this system after modeling the exact internal dimensions of the compressor cylinders, the inlet separator, suction and discharge pulsation bottles, and pipes that are currently in place. The simulation model accurately predicts the attenuation performance of the existing system that agrees with actual operating experience, which is that the existing traditional pulsation attenuation system is effective at reducing the pulsations, but it causes a significant pressure drop on both the suction and discharge sides of the compressor, thereby reducing its efficiency and flow capacity.

Comparisons of these results with a 2-loop PAN system show that the PAN system is very effective. Results are compared with both cylinders operating normally in a double-acting mode and with one cylinder operating double-acting while the other cylinder is operating in a single-acting mode. The PAN configuration uses the existing pulsation attenuation bottles, but with the internal baffles and choke tubes removed so that the bottles are simply plenums.

For the 2-loop PAN, the pipe upstream of the compressor cylinder suction flanges is connected to a first TST that splits the flow into tuned legs of 26 in. and 906 in. that are subsequently rejoined at a second TST that is connected to the main pipe upstream of a third TST that splits the flow into tuned legs of 26 in. and 788 in. that are subsequently rejoined at a fourth TST that is connected to the pipe immediately upstream of the plenum bottle mounted on the two cylinder suction flanges. The flow area of each leg of a tuned loop is approximately one-half of the area of the main pipe. On the discharge side of the compressor cylinder, immediately downstream of the plenum bottle that is mounted on the two cylinder discharge flanges, the pipe is connected to a fifth TST that splits the flow into tuned legs of 20 in. and 808 in. that are subsequently rejoined at a sixth TST that is connected to the main pipe upstream of a seventh TST that splits the flow into tuned legs of 20 in. and 959 in. that are subsequently rejoined at an eighth TST that is connected to the main pipe downstream of the cylinder. The comparatively long loop leg lengths in this system are a result of the significant low frequency pulsation that occurs when a cylinder end is deactivated. Without the requirement for this mode of operation, the PAN loop pipe lengths can be much shorter.

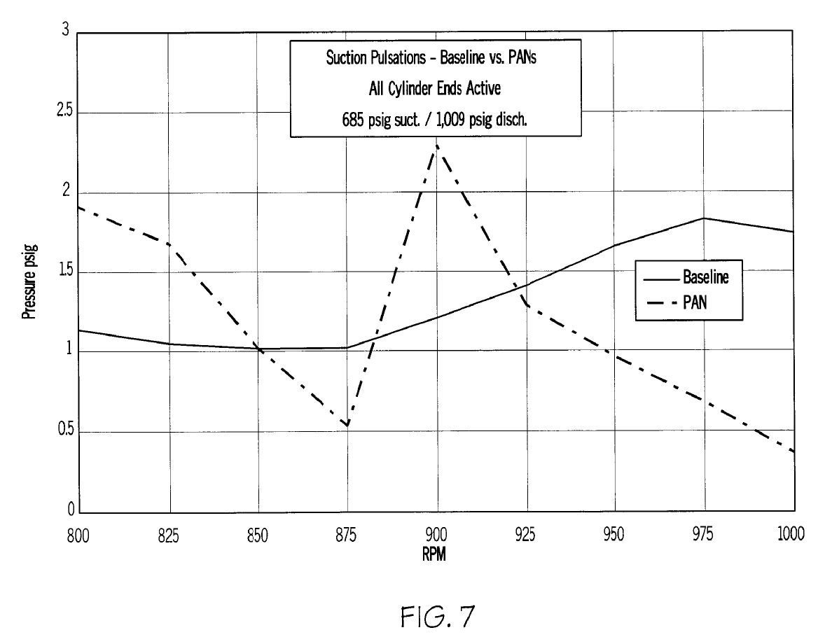

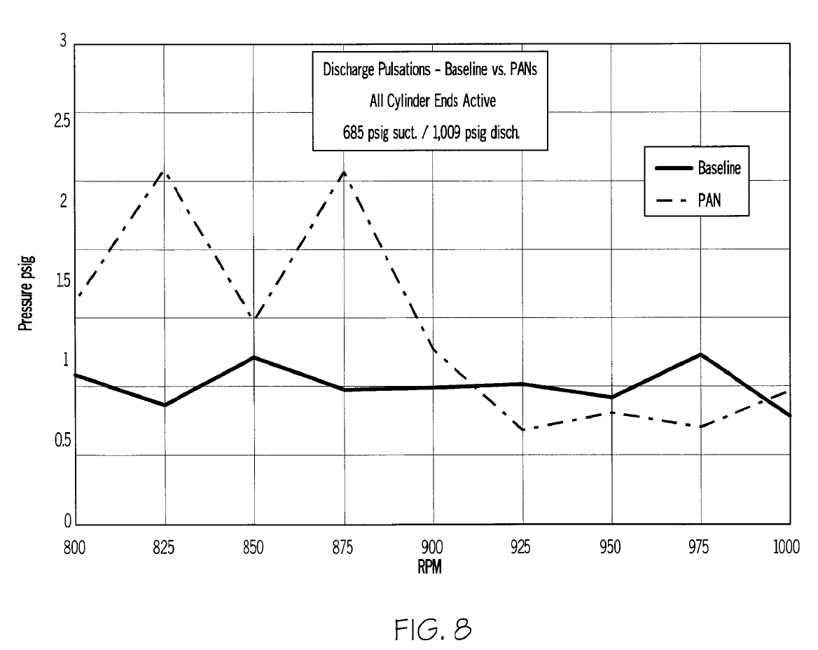

Operation with All Cylinder Ends Active: FIGS. 7 and 8 compare the peak-to-peak suction and discharge line pressure pulsations for a current baseline pulsation bottle system and a 2-loop PAN system with two 9.5 in. diameter UD cylinders, both operating in double-acting mode with all ends active. The term “UD” as used herein denotes a particular class or model designation of the Superior compressor line, manufactured by Cameron Compression Systems of Houston, Tex.

It is again emphasized that the existing traditional pulsation attenuation system provides excellent pulsation control in practice; however, the system pressure drop is typically higher than desired. With the 2-loop PAN system, suction pulsations peak at 2.2 psi (0.3% of the pressure level) at 900 rpm and reach their lowest level of 0.35 psi (<0.1% of the pressure level) at 1000 rpm. Discharge pulsations with the 2-loop PAN system are less than 6 psi (0.6% of the pressure level) throughout the speed range with a minimum level of 2.25 psi (0.2% of the pressure level) at 975 rpm. For all practical purposes, over the speed range, the PANs control pulsations to about the same degree as the existing pulsation attenuation system.

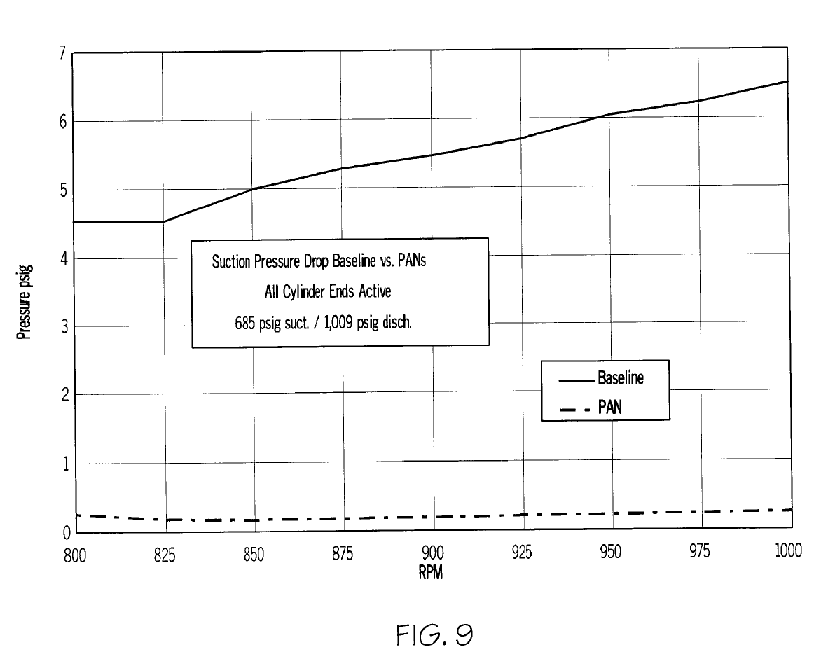

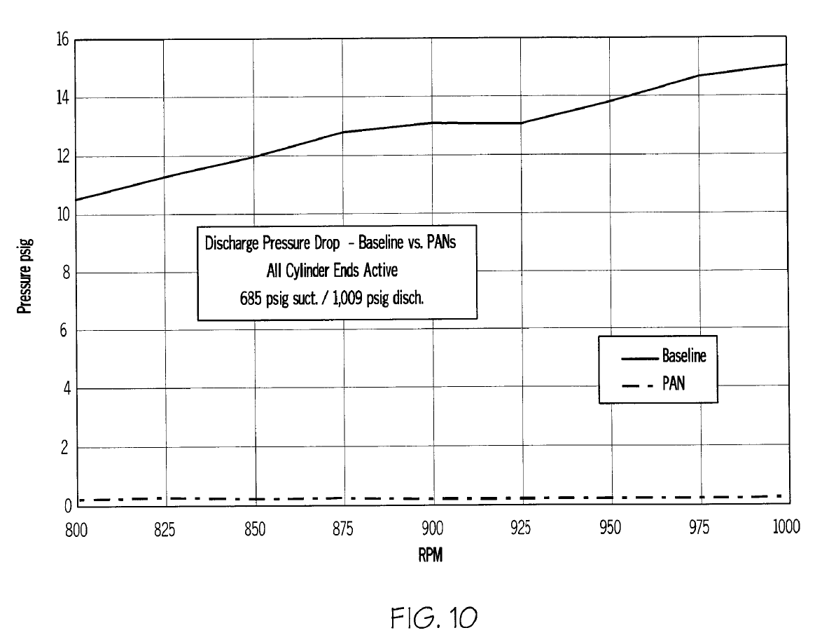

However, the line pressure losses with the 2-loop PAN system are dramatically less than achieved with the current traditional pulsation damping system, as shown in FIGS. 9 and 10. At 800 rpm, the PAN suction line pressure drop is 0.3 psi, or 93% less, compared to 4.6 psig for the current baseline system. At 1,000 rpm, the PAN suction pressure drop is 0.3 psi, or 95% less, compared to 6.4 psi for the existing system. Similarly, at 800 rpm, the PAN discharge line pressure drop is 0.2 psi, or 98% less, compared to 10.2 psi for the existing system. At 1000 rpm, the PAN discharge line pressure drop is 0.2 psig, or 99% less, compared to 15.0 psig for the existing system.

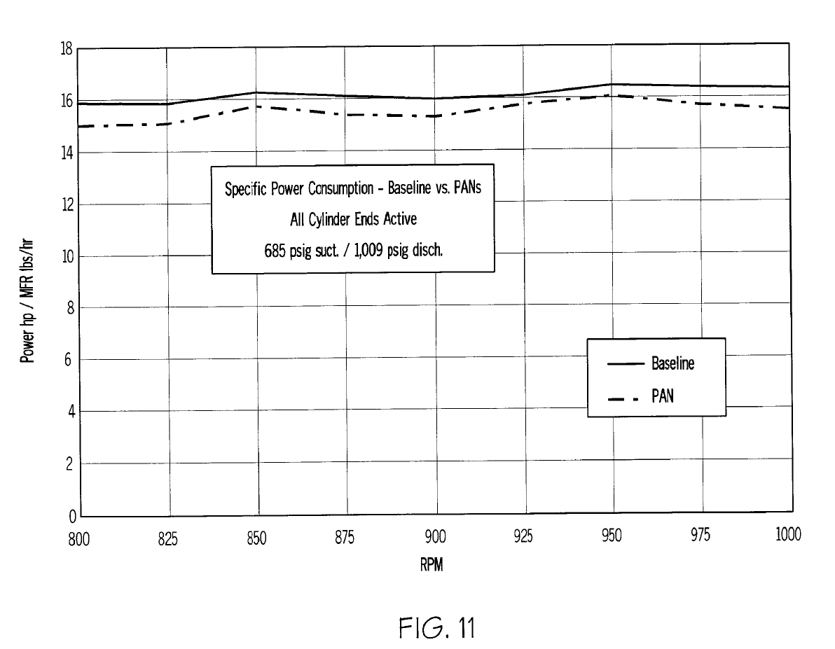

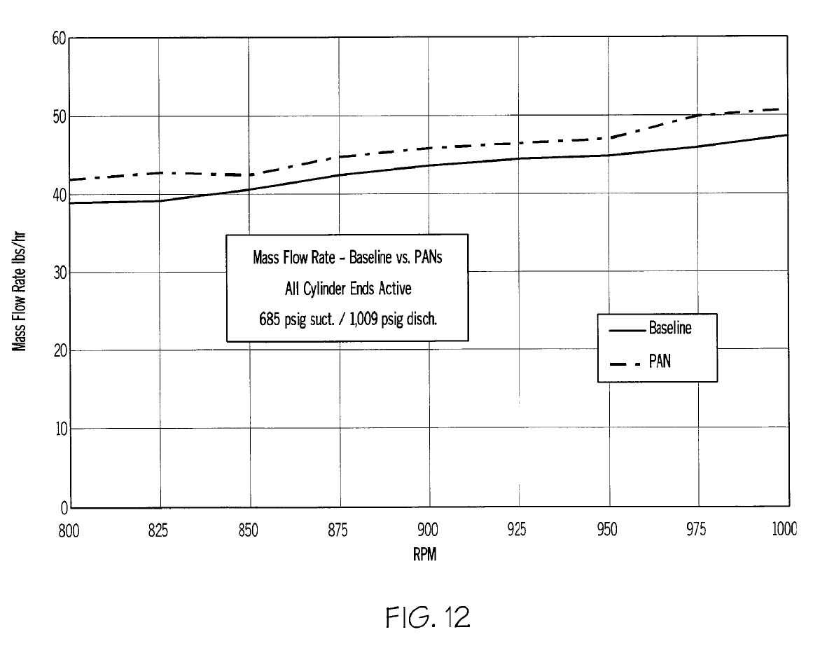

FIG. 11 shows the specific power consumption, or the overall efficiency, of the system. The 2-loop PAN system shows an overall efficiency increase of approximately 11% at all speeds compared to the existing traditional pulsation attenuation system. FIG. 12 shows that the compressor's capacity also increases about 11% compared to the existing system. It is important to note that these results are with limited optimization to determine the best possible combinations of loop pipe lengths, offset stub pipe lengths between the PANs and cylinder flanges, or pipe lengths between loops; however, they clearly demonstrate the significant potential for PANs to reduce system pressure drops and compressor engine fuel consumption while increasing the compression system's capacity.

Operation with One Cylinder Double-Acting and One Other Cylinder End Deactivated: A common mode of reciprocating compressor operation involves the deactivation of one or more cylinder ends. This is accomplished with a cylinder end deactivation device which, when operated, holds the suction valve wide open all of the time. This method of operation significantly increases the pulsations on both sides of the compressor cylinder with the suction side being affected the most. The deactivated side of the piston sucks and discharges its entire swept volume into the suction bottle once every revolution of the compressor, creating the maximum low frequency pulsation that it possibly can. This significantly complicates the attenuation for a traditional system as well as for a PAN system.

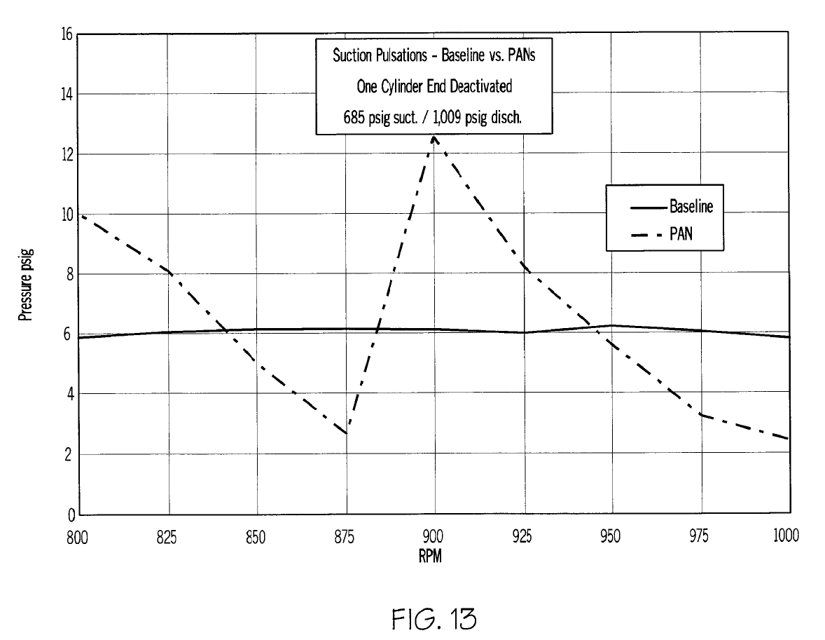

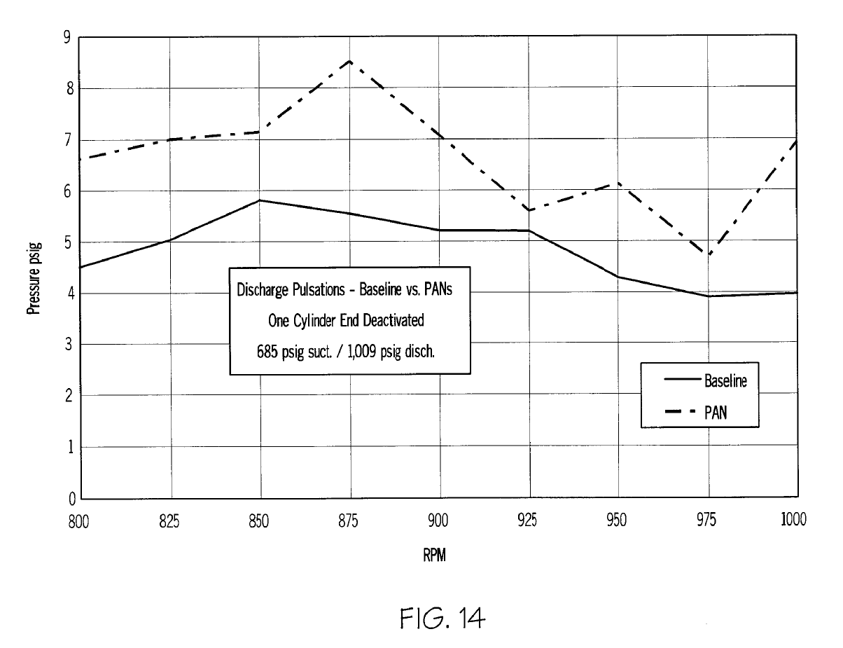

FIGS. 13 and 14 show the pulsations for the end deactivated operating condition. Because the deactivated mode was used as the base design case, this initial PAN system design performs almost as well in the deactivated mode as it did in the normal load (100% loaded) mode. The exception is at 900 rpm where the suction line pulsations increase to slightly over 12.5 psi (1.8% of the pressure level), which is still an acceptable level. At 1,000 rpm the PAN system operates at 2 psi of pulsation (0.3% of the pressure level) compared to 5.8 psi (0.8% of the pressure level) for the existing pulsation control system.

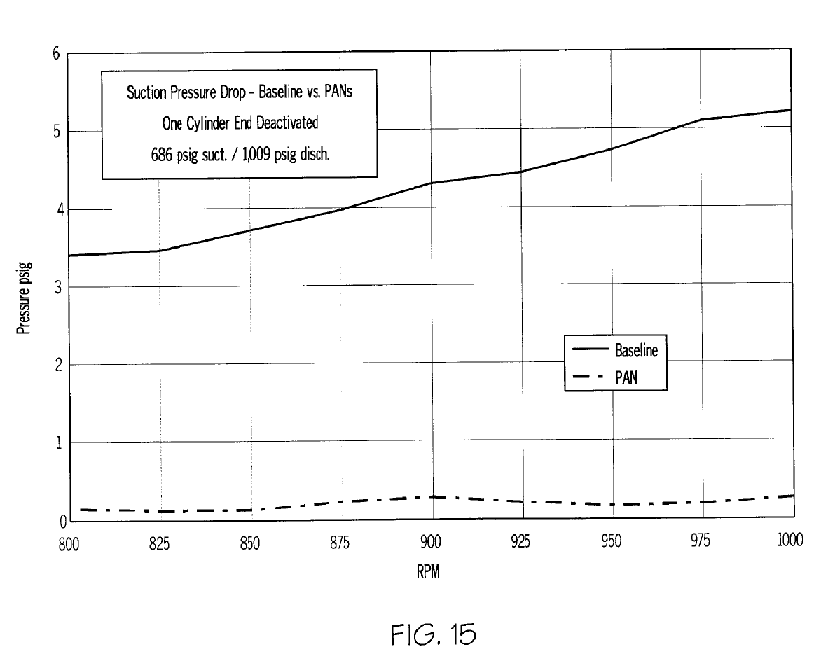

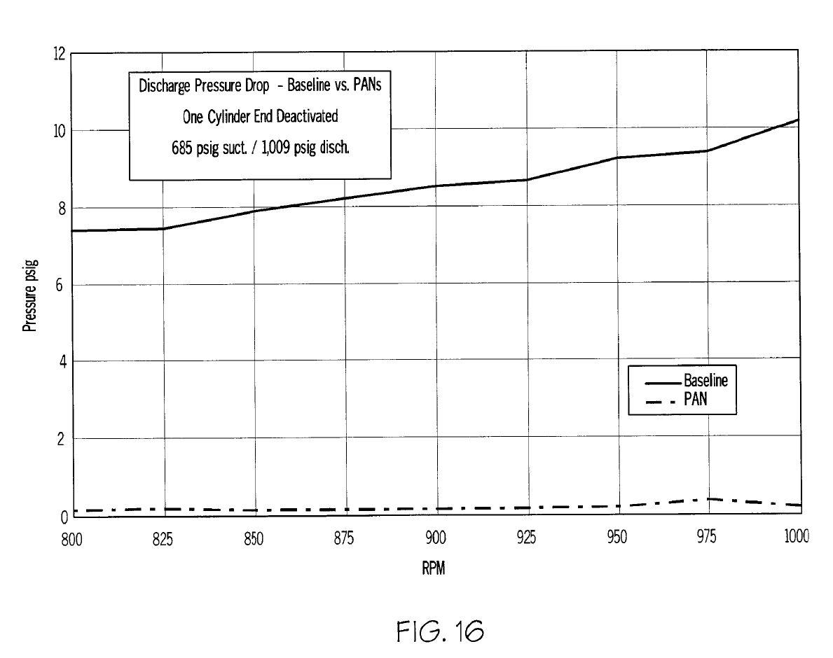

Pressure drops for the deactivated mode of operation are shown in FIGS. 15 and 16. The beneficial effects of the PANs are again dramatic with respect to pressure drop. At 1,000 rpm the PAN suction line pressure drop is 0.2 psig, or 96% less than the existing pulsation attenuation system. The PAN discharge line pressure drop is 0.2 psig, or 98% less than the existing system.

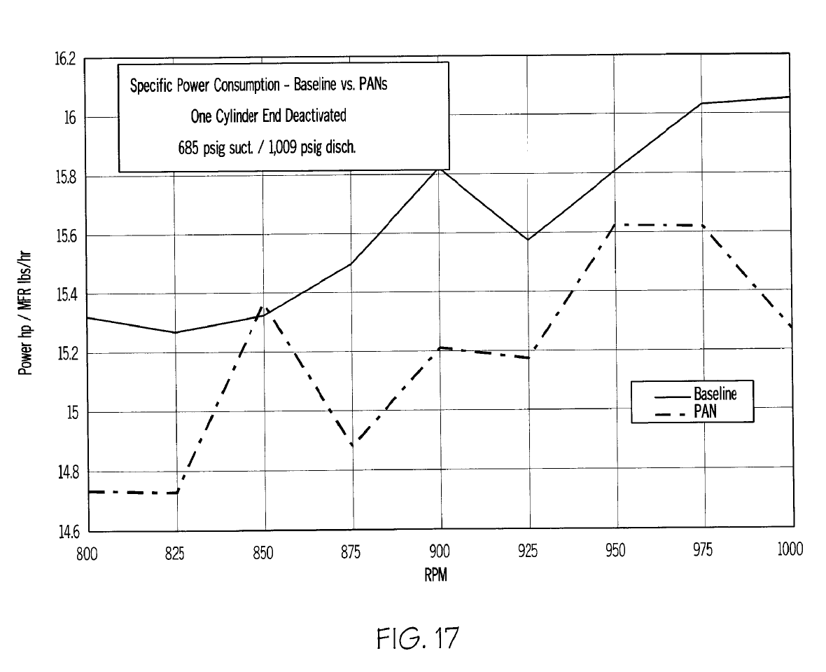

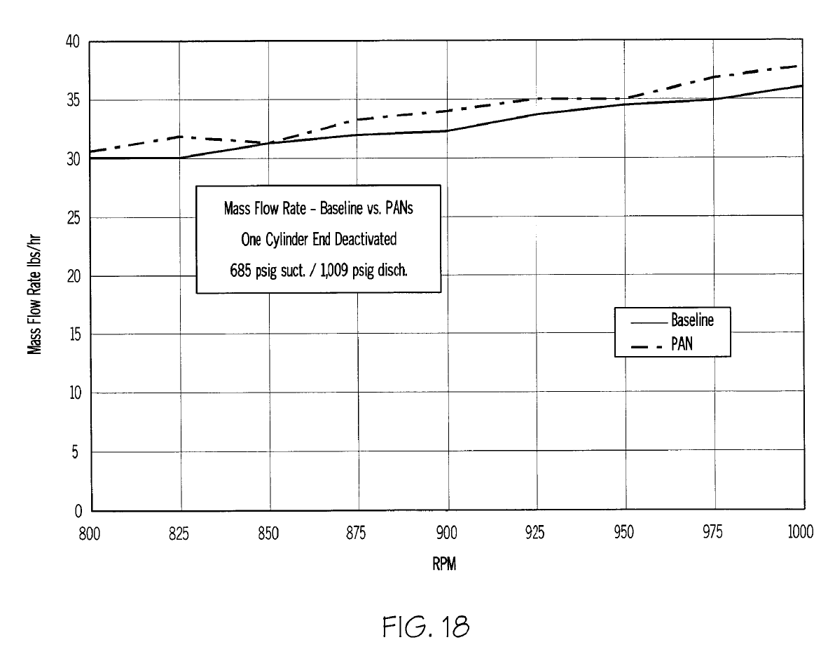

FIGS. 17 and 18 show the specific power consumption and mass flow rates for the deactivated mode. Although the specific power reduction is not as dramatic as with the single cylinder results, it still results in an average reduction of around 3% over the speed range. It is important to note that this improvement is additive to the power reduction that results from the reduced overall system pressure drop. The foregoing example presents only a limited illustration of the vast range of systems and applications to which the PAN can be applied. The technology is utilizable for reciprocating compressor systems operating in any kind of operation or service with any gaseous fluid at any pressure, temperature or flow condition. By employing finite amplitude wave simulation technology via a network of single or multiple sequential tuned loops of pipe, connected by the tuning section transition devices of the present invention, the PAN can cancel, rather than dampen, the complex pressure waves that emanate from reciprocating compressor cylinders, without causing significant system pressure losses.

The TST of the present invention will enable and greatly simplify the fabrication and cost of the tuned loops for the PAN system, while providing precise internal transition geometry at the divergence and convergence of the tuned loops or branches. It can enable the advancement and application of the PAN system technology into industrial and commercial applications that utilize reciprocating compressors.

While the present invention has been illustrated by the description of embodiments and examples thereof, it is not intended to restrict or in any way limit the scope of the appended claims to such detail. Additional advantages and modifications will be readily apparent to those skilled in the art. Accordingly, departures may be made from such details without departing from the scope or spirit of the invention.

What is claimed is:

1. A branching device for creating a divergence point and/or a convergence point for a section of a pulsation attenuation network, the device comprising:
a. a large flow channel;
b. two small flow channels; and
c. a divider that transitions the single large flow channel into the two small flow channels internally, wherein the divider is adapted to prevent the creation of significant disturbances in fluid flow patterns through the device.

2. The device of claim 1, wherein the areas of each of the small flow channels are between about 25% to about 75% of the large flow channel.

3. The device of claim 2, wherein the areas of each of the small flow channels are between about 45% to about 55% of the large flow channel.

4. The device of claim 1, wherein the device is adapted to accommodate flow in either direction, that is, either flow entering the device at the large flow channel and exiting through the two small flow channels, or flow entering at the two small flow channels and exiting through the large flow channel.

5. The device of claim 1, wherein the flow channels are between about 1 inch in diameter to about 24 inches in diameter.

6. The device of claim 1, wherein the device is adapted to safely withstand pressures of between about 125 psig to about 2500 psig.

7. The device of claim 6, wherein the pressures are between about 1000 psig to about 2000 psig.

8. The device of claim 7, wherein the pressures are between about 1200 psig to about 1500 psig.

9. The device of claim 1, wherein the ports are adapted to connect to either standard or custom-designed flanged connections that can be secured by threaded fasteners, clamps, compression sleeves or other means.

10. The device of claim 1, wherein the ports include beveled ends that can be welded directly to standard industrial pipes.

11. The device of claim 1, further including one or more internal sleeves or liners in the ports for the purpose of changing the geometry, adapting the area to standard pipe sizes, transitioning the geometry, providing renewable flow surfaces, or for other purposes.

12. In a pulsation attenuation network, a branching device comprising:
a. a first large flow channel;
b. a first divider adapted to transition the first large flow channel into a first small flow channel and a second small flow channel, wherein the second small flow channel is configured to diverge from the first small flow channel;
c. a third small flow channel adapted to converge with the first small flow channel into a second large flow channel; and
d. a second divider adapted to transition the first and third small flow channels into the second large flow channel, wherein the dividers are operable to prevent the creation of significant disturbances in fluid flow patterns through the device.

13. The device of claim 12, wherein the area of each of the small flow channels is preferably between about 25% to about 75% of the large flow channel, and more preferably between about 45% to about 55% of the large flow channel.

14. The device of claim 12, wherein the device is adapted to accommodate flow in either direction, that is, either flow entering the device at the first large flow channel and exiting through the second large flow channel, or flow entering at the second large flow channel and exiting through the first large flow channel.

15. The device of claim 12, wherein the flow channels are between about 1 inch in diameter to about 24 inches in diameter.

16. The device of claim 12, wherein the device is adapted to safely withstand pressures of between about 125 psig to about 2500 psig, wherein the pressures are preferably between about 1000 psig to about 2000 psig, and more preferably between about 1200 psig to about 1500 psig.

17. The device of claim 12, further including one or more internal sleeves or liners in the ports for the purpose of changing the geometry, adapting the area to standard pipe sizes, transitioning the geometry, providing renewable flow surfaces, or for other purposes.

18. A branching device for creating a divergence point and/or a convergence point for a section of a pulsation attenuation network, the device comprising:
a. at least one large flow channel;
b. at least two small flow channels; and
c. at least one divider that transitions the large flow channel into the two small flow channels internally, wherein the divider is adapted to prevent the creation of significant disturbances in fluid flow patterns through the device, and wherein the device is adapted to accommodate flow in either direction.

19. The device of claim 18, wherein the area of each of the at least two small flow channels is preferably between about 25% to about 75% of the at least one large flow channel, and more preferably between about 45% to about 55% of the at least one large flow channel.

20. The device of claim 18, wherein the device is adapted to safely withstand pressures of between about 125 psig to about 2500 psig, wherein the pressures are preferably between about 1000 psig to about 2000 psig, and more preferably between about 1200 psig to about 1500 psig.
